(19) United States
(12) Patent Application Publication
(10) Pub. No.: US 2014/0188834 A1
(43) Pub. Date: Jul. 3, 2014

(54) ELECTRONIC DEVICE AND VIDEO CONTENT SEARCH METHOD

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: Xin GUO, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/138,129

(22) Filed: Dec. 23, 2013

(30) Foreign Application Priority Data
Dec. 28, 2012 (CN) 2012105841875

(51) Int. Cl. G06F 17/30

(52) U.S. Cl. CPC G06F 17/30787
USPC 707/706

(57) ABSTRACT

In a video content search method, a video content is selected from a video currently being played. The selected video content is analyzed to obtain audio data or obtain a frame comprising pictures and/or subtitles, of the video. The audio data is converted into one or more words, and one or more words in the subtitle or the one or more pictures are extracted from the frame. Then, a search is executed based on the words or the pictures.

### BACKGROUND

1. Technical Field

Embodiments of the present disclosure relate to query processing, and more specifically relates to techniques for searching web pages according to a selected video content in a video.

2. Description of Related Art

People seek information from the Internet using a web browser. A person begins his/her search for information by pointing his/her web browser at a website associated with a search engine. The search engine allows a user to request web pages containing information related to a particular search keyword. For an accurate search result, the search keyword is important.

When watching a video, a user may see or hear some unknown words or phrases, see some unacquainted people in the video. Thus, the user may want to search information about the unknown words or phrase, or the unacquainted people from the Internet. However, it may be difficult for the user to determine keywords about the unacquainted people, or it may be difficult for the user to input the unknown words or phrase into a search engine.

### BRIEF DESCRIPTION OF THE DRAWINGS

FIG. 1 is a block diagram of one embodiment of an electronic device that includes a video content search system.

FIG. 2 is a block diagram of one embodiment of function modules of the video content search system.

FIG. 3 is a flowchart of one embodiment of a video content searching method.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

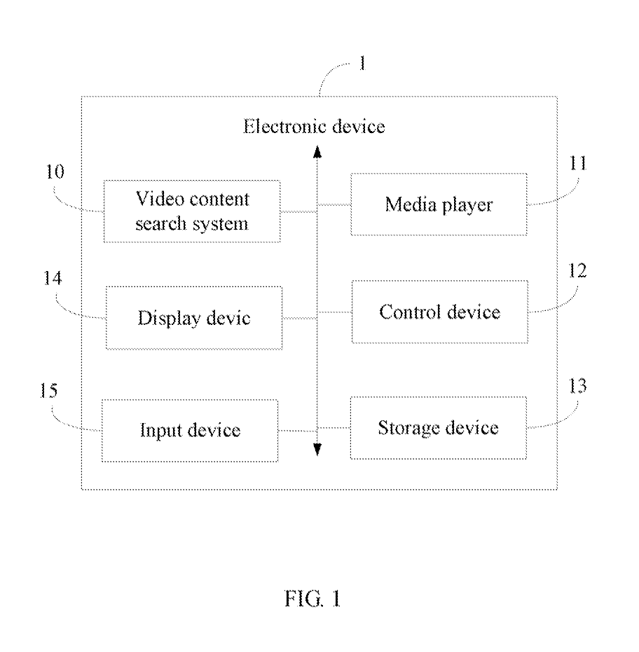

FIG. 1 is a block diagram of one embodiment of an electronic device 1 that includes a video content search system 10. The electronic device 1 may be a computer, or a personal digital assistant (PDA), a smart phone, for example. The electronic device 1 further includes a media player 11, a control device 12, a storage device 13, a display device 14, and an input device 15. One skilled in the art recognizes that the electronic device 1 may be configured in a number of other ways and may include other or different components.

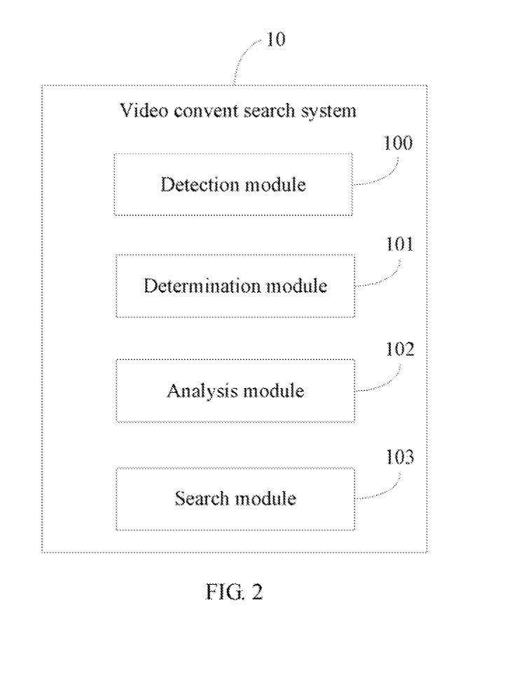

The video content search system 10 includes computerized codes in the form of one or more programs, which are stored in the storage device 13. In the present embodiment, the one or more programs of the video content search system 10 are described in the form of function modules (see FIG. 2), which are executed by the control device 12 to perform functions of searching web pages according to a selected video content in a video.

The control device 12 may be a processor, a microprocessor, an application-specific integrated circuit (ASIC), or a field programmable gate array, (FPGA) for example.

The storage device 13 may include some type(s) of non-transitory computer-readable storage mediums, such as a hard disk drive, a compact disc, a digital video disc, or a tape drive.

The storage device 13 stores videos that can be played by the media player 11. Each of the videos includes a plurality of video frames. Each frame is constituted by one or more pictures, audio data, and subtitles.

The display device 14 displays the videos stored in the storage device 13 when the videos are played by the media player 11.

The input device 15 may be a mouse or stylus, for example.

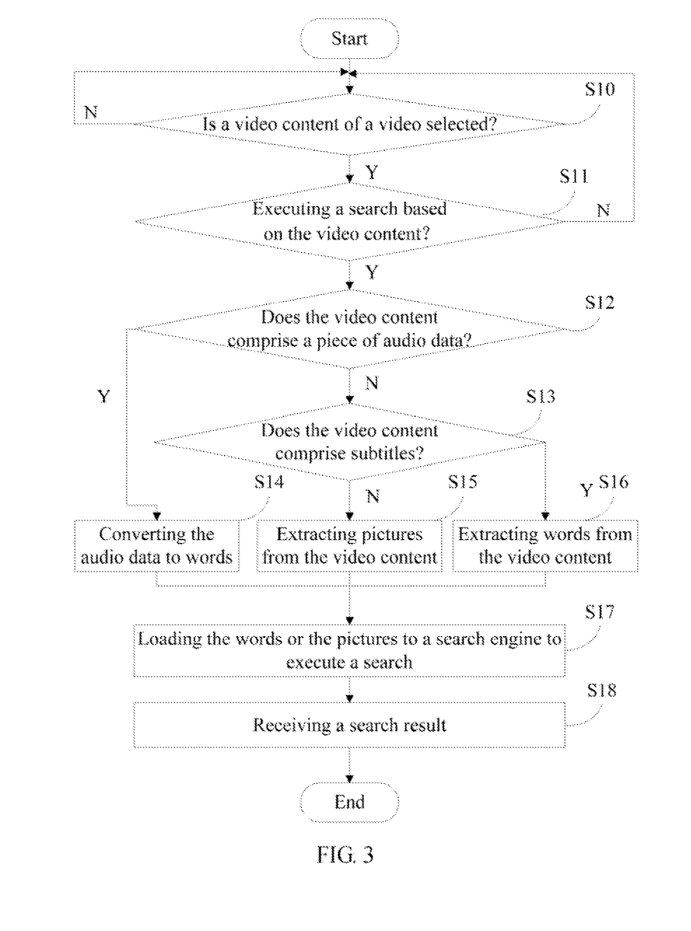

FIG. 2 is a block diagram of one embodiment of function modules of the video content search system 10. In one embodiment, the video content search system 10 includes a detection module 100, a determination module 101, an analysis module 102, and a search module 103. The function modules 100-103 provide at least the functions needed to execute the steps illustrated in FIG. 3 below.

FIG. 3 is a flowchart of one embodiment of a video content searching method. Depending on the embodiment, additional steps in FIG. 3 may be added, others removed, and the ordering of the steps may be changed.

In step S10, the detection module 100 determines if a video content of a video currently being played by the media player 11 is selected. The video content may comprise audio data, one or more pictures in one or more frames, or subtitles in one or more frames. In one embodiment, the video content can be selected in a frame of the video using a closed polygonal chain by the input device 15, or by clicking on two frames in the video by the input device 15 in a predetermined time period, such as 30 seconds. In one embodiment, when selecting the video content using closed polygonal chain, one or more pictures and/or subtitles in a closed area formed by the closed polygonal chain are the selected video content. When clicking on two frames in the video, audio data relating to frames between the two clicked frames are the selected video content. Step S11 is implemented when a video content of a video currently being played by the media player 11 is selected. Otherwise, step S10 is repeated when no video content of a video currently being played by the media player 11 is selected.

In step S11, the determination module 101 determines if a search based on the selected video content is executed. In one embodiment, when the detection module 100 determines that a video content of a video currently being played by the media player 11 is selected, a popup dialog box comprising a confirmation option and a deny option is displayed for a user to confirm a search. When the user selects the confirmation option, the determination module 101 determines that a search based on the selected video content is executed, then step S12 is implemented. Otherwise, when the user selects the deny option, the determination module 101 determines that no search based on the selected video content is executed, then step S10 is repeated.

In step S12, the analysis module 102 determines if the selected video content comprise audio data. As mentioned above, if the video content is selected by clicking on two frames in the video in a predetermined time period, the analysis module 102 determines that the selected video content comprises audio data, then step S14 is implemented. Otherwise, if the video content is not selected by clicking on two frames in the video in a predetermined time period, the analysis module 102 determines that the selected video content does not comprise audio data, then step S13 is implemented.

In step S13, the analysis module 102 further determines if the selected video content comprises subtitles. As mentioned above, if the video content is selected in a frame of the video using a closed polygonal chain, the analysis module 102 analyzes the video content in a closed area formed by the closed polygonal chain to determine if the video content comprise subtitles. If the selected video content comprises subtitles, step S16 is implemented. Otherwise, if the selected video content does not comprise subtitles, step S15 is implemented.

In step S14, the analysis module 102 converts the audio data in the selected video content into one or more words.

In step S15, the analysis module 102 extracts one or more pictures from the selected video content.

In step S16, the analysis module 102 extracts one or more words from the selected video content.

In step S17, the search module 103 loads the words or the pictures to a search engine to execute a search.

In step S18, the search module 103 receives a search result returned by the search engine.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A video content searching method, the method being executed by at least one processor of an electronic device, the method comprising:
receiving a video content selected from a video currently being played;
analyzing the selected video content to obtain audio data or obtain a frame comprising pictures and/or subtitles, of the video;
converting the audio data into one or more words, and extracting one or more words in the subtitle or the one or more pictures from the frame;
loading the words or the pictures to a search engine to execute a search; and
receiving a search result returned by the search engine.

2. The method according to claim 1, wherein the video content is selected in a frame of the video using a closed polygonal chain or by clicking on two frames in the video in a predetermined time period using an input device.

3. The method according to claim 2, wherein the selected video content comprises the one or more pictures and/or the subtitles in a closed area formed by the closed polygonal chain.

4. The method according to claim 2, wherein the selected video content comprises audio data relating to frames between the two clicked frames.

5. An electronic device, comprising:
a control device; and
a storage device storing one or more programs which when executed by the control device, causes the processing device to:
receive a video content selected from a video currently being played;
analyze the selected video content to obtain audio data or obtain a frame comprising pictures and/or subtitles, of the video;
convert the audio data into one or more words, and extracting one or more words in the subtitle or the one or more pictures from the frame;
load the words or the pictures to a search engine to execute a search; and
receive a search result returned by the search engine.

6. The electronic device according to claim 5, wherein the video content is selected in a frame of the video using a closed polygonal chain or by clicking on two frames in the video in a predetermined time period using an input device.

7. The electronic device according to claim 6, wherein the selected video content comprises the one or more pictures and/or the subtitles in a closed area formed by the closed polygonal chain.

8. The electronic device according to claim 6, wherein the selected video content comprises audio data relating to frames between the two clicked frames.

9. A non-transitory storage medium having stored thereon instructions that, when executed by a processor of an electronic device, causes the processor to perform a video content searching method, wherein the method comprises:
receiving a video content selected from a video currently being played;
analyzing the selected video content to obtain audio data or obtain a frame comprising pictures and/or subtitles, of the video;
converting the audio data into one or more words, and extracting one or more words in the subtitle or the one or more pictures from the frame;
loading the words or the pictures to a search engine to execute a search; and
receiving a search result returned by the search engine.

10. The non-transitory storage medium according to claim 9, wherein the video content is selected in a frame of the video using a closed polygonal chain or by clicking on two frames in the video in a predetermined time period using an input device.

11. The non-transitory storage medium according to claim 10, wherein the selected video content comprises the one or more pictures and/or the subtitles in a closed area formed by the closed polygonal chain.

12. The non-transitory storage medium according to claim 10, wherein the selected video content comprises audio data relating to frames between the two clicked frame.
